(19) United States
(12) Patent Application Publication
(10) Pub. No.: US 2010/0308023 A1
(43) Pub. Date: Dec. 9, 2010

(54) Laser cutting device for a workpiece having a surface immersed in a liquid

(76) Inventor: Chia-Lung Kuo, Douliou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/591,384

(22) Filed: Nov. 18, 2009

(30) Foreign Application Priority Data
Jun. 4, 2009 (TW) 098118582

(51) Int. Cl. B23K 26/00

(52) U.S. Cl. 219/121.67

(57) ABSTRACT

A laser cutting device for a workpiece having a surface immersed in a liquid includes a liquid container, a workpiece holder, and a laser generator. The liquid container is provided for storing a liquid. The workpiece holder is provided for securing a workpiece. The workpiece has a first surface and a second surface. The first surface is immersed in the liquid. The function of this laser generator is to generate a laser beam to the second surface so as to cut the workpiece. So, the cutting quality is good. Plus, the cooling effect is excellent.

### BACKGROUND OF THE INVENTION

1. Field of the Invention

The present invention relates to a laser cutting device for a workpiece having a surface immersed in a liquid. The cutting quality is good. Plus, the cooling effect is excellent.

2. Description of the Prior Art

Referring to FIGS. 1, 2A, 2B and 2C, the traditional laser cutting device includes a laser generator 930 that can generate a laser beam 931 to a workpiece 950. This laser cutting process occurs in an environment of air.

However, cooling by air is less effective. It is easy to cause high temperature, cracking, or rough surfaces, etc. Hence, the cutting quality is poor. As shown in FIG. 2C, after the laser beam cutting the workpiece 950, burrs 952 are generated on an upper surface 951A and on a lower upper surface 951B. Thus, the surfaces are not flat.

If a laser beam cuts a glass, it might cause cracking, burr, cutting debris, and over-heating phenomenon on the cutting edge. If the glass is placed in a liquid for laser cutting, the internal temperature gradient can be reduced, so the occurrence of crack can be minimized. Also, the liquid is helpful for removing the cutting debris more effectively.

But, when laser beam propagates in a liquid, it will be interfered or absorbed by the liquid. Depending on the types of laser and liquid, the energy loss of the laser beam will be different. For example, when the laser is the CO₂ laser and the liquid is water, the water will absorb CO₂ laser greatly. Under this condition, the energy loss of this laser beam is relatively high.

### SUMMARY OF THE INVENTION

The object of the present invention is to provide a laser cutting device for a workpiece having a surface immersed in a liquid. In which, the cutting quality is good. Plus, the cooling effect is excellent. Hence, this invention can solve the problems about the traditional laser cutting quality is poor and the laser beam is easy to be interfered by a liquid.

In order to solve the above-mentioned problems, the present invention is provided. A laser cutting device for a workpiece having a surface immersed in a liquid comprising:
a liquid container for storing a liquid;

a workpiece holder for securing a workpiece, the workpiece having a first surface and a second surface, the first surface being immersed in the liquid; and
a laser generator for generating a laser beam to the second surface so as to cut the workpiece.

### BRIEF DESCRIPTION OF THE DRAWINGS

FIG. 1 is a perspective view of a traditional laser cutting device.

FIG. 2A shows the cutting process one of the traditional laser cutting device.

FIG. 2B shows the cutting process two of the traditional laser cutting device.

FIG. 2C shows the cutting process three of the traditional laser cutting device.

FIG. 3 is a first preferred embodiment of the present invention.

FIG. 4A shows the cutting process one of the present invention.

FIG. 4B shows the cutting process two of the present invention.

FIG. 4C shows the cutting process three of the present invention.

FIG. 5 illustrates the second preferred embodiment of the present invention.

FIG. 6 illustrates the third preferred embodiment of the present invention.

FIG. 7 is a view showing a portion in the third preferred embodiment of the present invention.

FIG. 8 illustrates the fourth preferred embodiment of the present invention.

FIG. 9 is a view showing a portion in the fourth preferred embodiment of the present invention.

FIG. 10A shows the fifth preferred embodiment of the present invention.

FIG. 10B is a view showing a portion in the fifth preferred embodiment of the present invention.

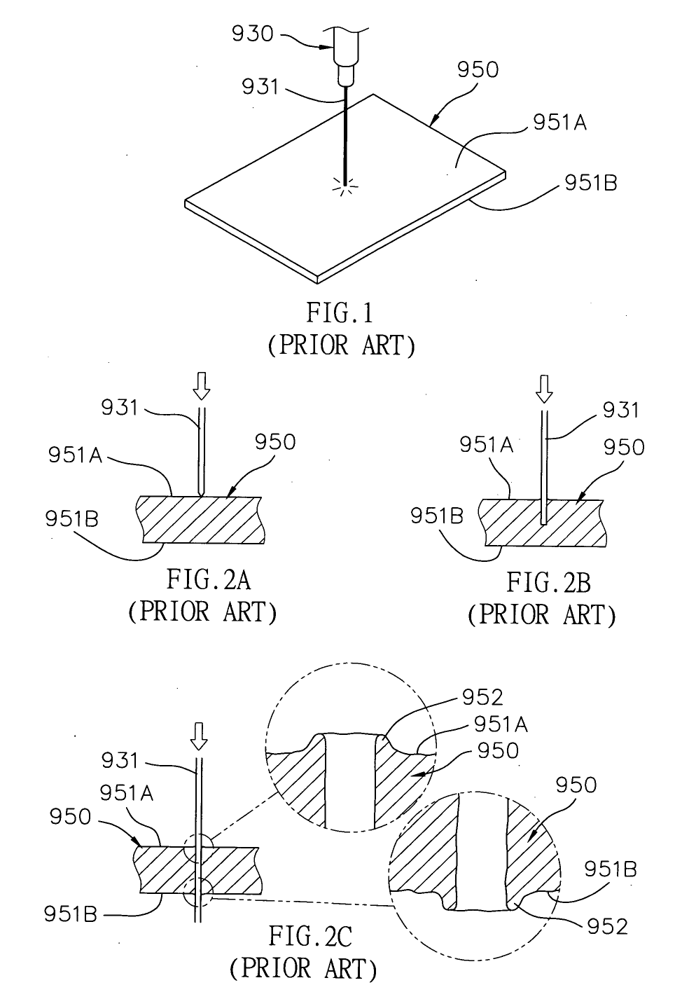

### DETAILED DESCRIPTION OF THE PREFERRED EMBODIMENT

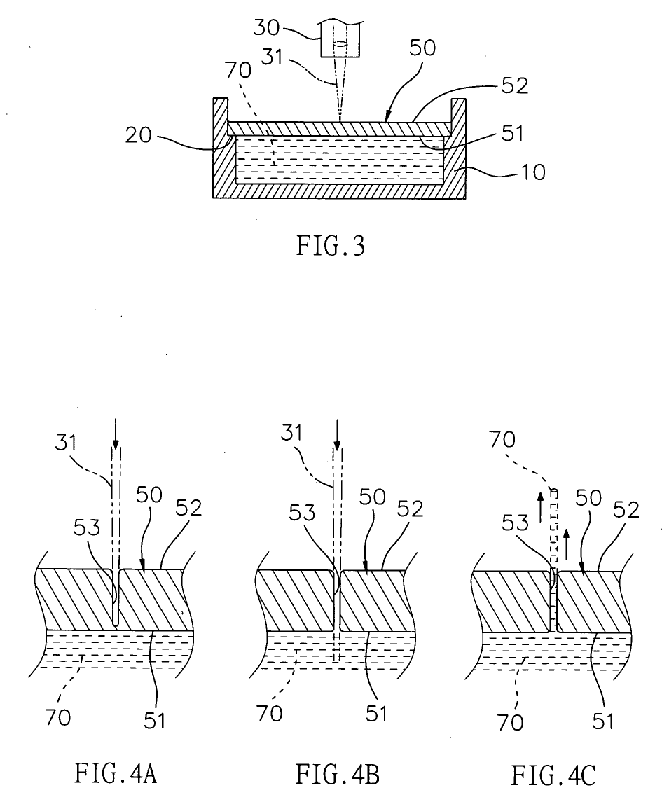

Referring to FIGS. 3 and 4A, this invention is a laser cutting device for a workpiece having a surface immersed in a liquid. It mainly includes a liquid container 10, a workpiece holder 20, and a laser generator 30.

About this liquid container 10, it is provided for storing a liquid 70 (such as water).

Regarding this workpiece holder 20, it is provided for securing a workpiece 50. The workpiece 50 has a first surface 51 and a second surface 52. The first surface 51 is immersed in the liquid 70.

The function of this laser generator 30 is to generate a laser beam 31 to the second surface 52 so as to cut the workpiece 50.

As shown in FIGS. 4A and 4B, the laser beam 31 cuts the workpiece 50 and then cuts it through (from the second surface 52 to the first surface 51). Hence, a cutting wall 53 is formed. As illustrated in FIG. 4C, when the laser beam 31 reaches the first surface 51, the liquid 70 below the first surface 51 will absorb the energy (energy concentration leads a sharp expansion of the liquid 70) so that it will rush (or burst) into the narrow space by the cutting wall 53 toward the second surface 52. At the moment, it can remove cutting debris and sharp edges generated during the cutting process.

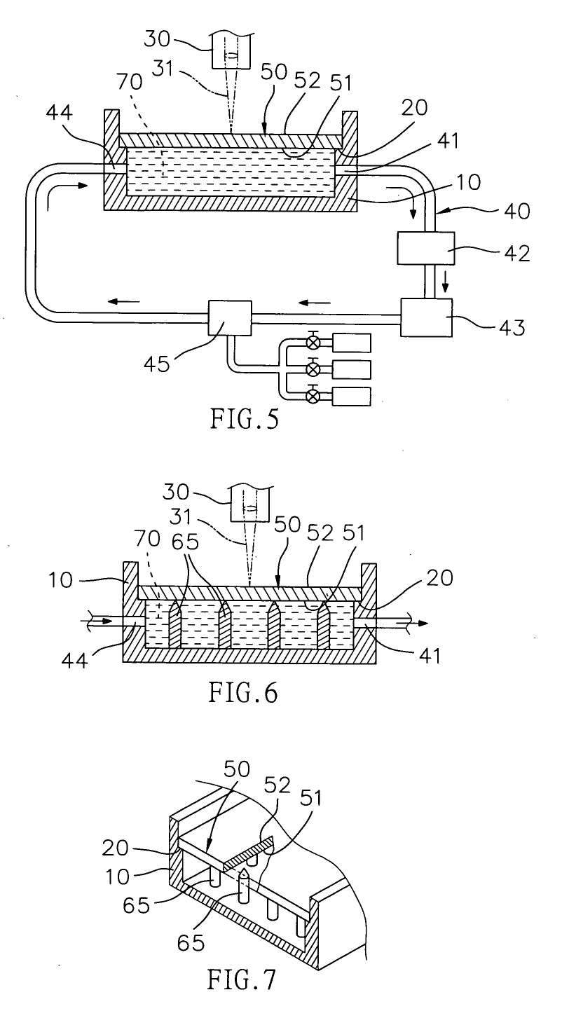

Referring to FIG. 5, this invention can further include a circulating system 40. This circulating system 40 includes an inlet 41, a circulation generator 42, a circulation filter 43, and an outlet 44. The inlet 41 and the outlet 44 connect with the liquid container 10. The circulation generator 42 forces the liquid 70 entering the inlet 41 and then passing through the circulation filter 43 for filtering and finally flowing back to the liquid container 10 via the outlet 44. In addition, a supplier 45 can be installed for supplying a predetermined object mixed with the liquid 70. The predetermined object can be a solid, liquid, gaseous object or a combination thereof. For example, the liquid 70 is mixed with a plurality of small grinding particles (solid object, not shown). When the liquid 70 rush into the space by the cutting wall 53, these small grinding particles can refine the surface of the cutting wall 53. Thus, it increases the surface quality of the cutting wall 53 and related edges (that is, reducing its surface roughness).

As illustrated in FIGS. 6 and 7, a plurality of supports 65 can be added in this invention, depending on the user's need. These supports 65 are disposed between the liquid container 10 and the first surface 51 of the workpiece 50 so as to support this workpiece 50. Particularly, when a workpiece is cut by the laser beam 31, the separated parts of the workpiece might fall down, if there is no any support. Assuming that this workpiece 50 is cut into several pieces, these pieces (of the workpiece 50) can be supported by these support 65 (preventing falling down after cutting).

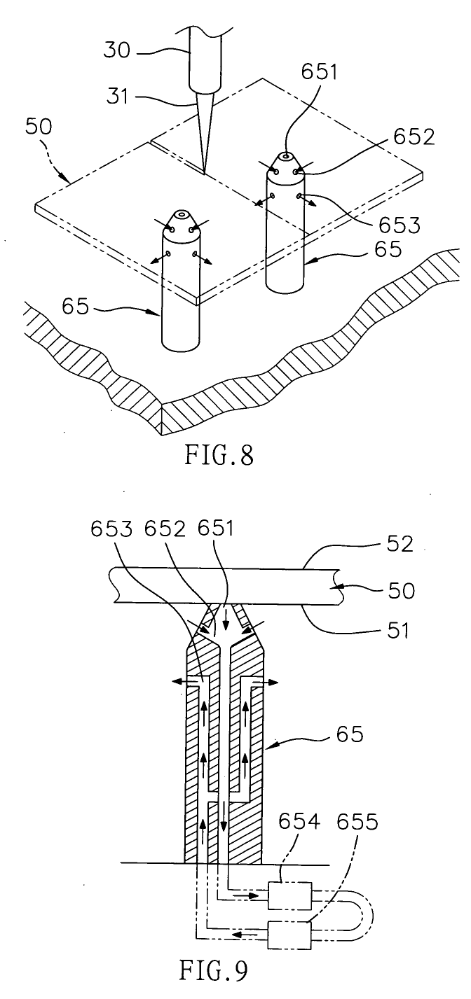

As shown in FIGS. 8 and 9, the support 65 can be modified as a circulation-type design. The modified support 65 includes a sucking portion 651, an inlet passage 652, an outlet passage 653, a driving portion 654, and a filtering portion 655. The driving portion 654 is provided to suck the liquid 70 into the inlet passage 652 and make the sucking portion 651 generating a sucking force on the first surface 51 of the workpiece 50. The liquid 70 in the inlet passage 652 is guided into the filtering portion 655 and then is expelled via the outlet passage 653. Hence, a complete circulation is done. In this embodiment, it also achieves the functions of generating a sucking force on the workpiece 50 and filtering the liquid 70.

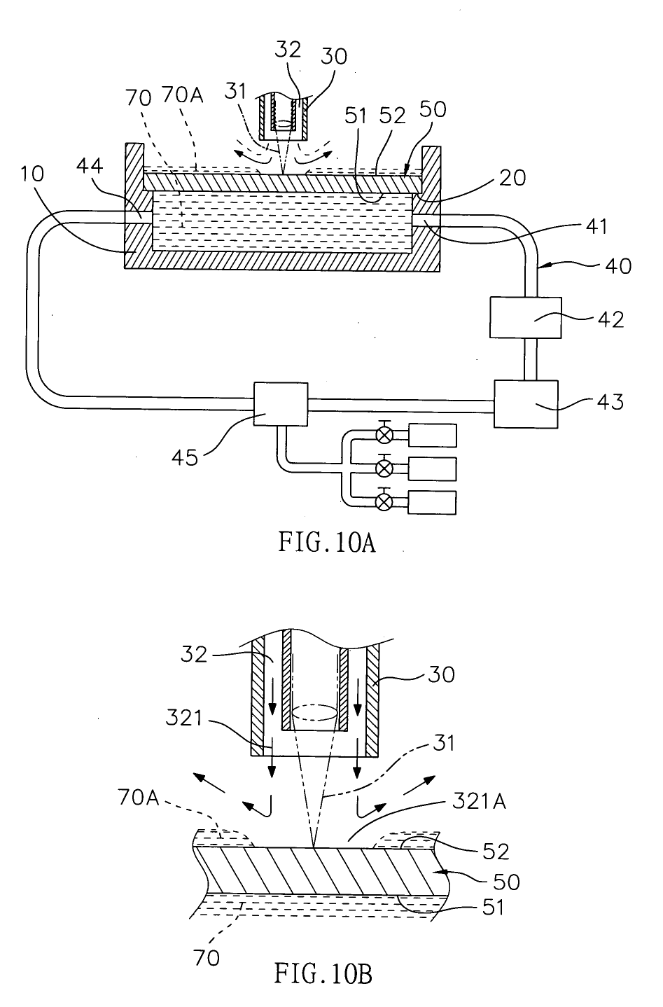

Of course, another preferred embodiment of this invention can be seen in FIGS. 10A and 10B. The surface of the liquid 70 is higher than the second surface 52 so as to form a liquid thin film 70A. Under this condition, it can significantly reduce the cutting temperature and remove the cutting debris. Moreover, it is optional that the laser generator further includes a gas-injecting portion 32 for injecting a gas 321 to the second surface 52 of the workpiece 50 so as to form a gas working zone 321A. This gas working zone 321A can force the liquid thin film 70A out of the gas working zone 321A. That is, due to existence of the gas working zone 321A, the laser beam 31 will not be interfered by the liquid thin film 70A during the laser cutting process.

The advantages and functions of this invention can be summarized as follows.

[1] The cutting quality is good. About the traditional laser cutting device 90, the laser cuts the workpiece within air. The traditional one is easy to cause many problems such as high temperature, cracking, rough surface, etc. So, its cutting quality is poor. However, the first surface 51 of the workpiece 50 of this invention is immersed in liquid. At the moment that the cutting wall 53 extends through, the liquid 70 below the first surface 51 rushes toward the direction of the second surface 52 via the narrow space by the cutting wall 53. Meanwhile, it can remove some cutting debris and sharp edges generated during the cutting process. Thus, the cutting quality is good.

[2] The cooling effect is excellent. One of the problems of the traditional laser cutting device (work within air) is the temperature of the workpiece is too high. It is bad for the material. However, the first surface 51 of the workpiece 50 of this invention is immersed in a liquid 70. It has a great cooling effect. Of course, if both of the first surface 51 and the second surface 52 are immersed in a liquid 70, its cooling effect will be better.

While this invention has been particularly shown and described with references to the preferred embodiments thereof, it will be understood by those skilled in the art that various changes or modifications can be made therein without departing from the scope of the invention by the appended claims.

What is claimed is:

1. A laser cutting device for a workpiece having a surface immersed in a liquid comprising:
a liquid container for storing a liquid;
a workpiece holder for securing a workpiece, said workpiece having a first surface and a second surface, said first surface being immersed in said liquid; and
a laser generator for generating a laser beam to said second surface so as to cut said workpiece.

2. The laser cutting device for a workpiece having a surface immersed in a liquid as claimed in claim 1, further comprising:
a circulating system including an inlet, a circulation generator, a circulation filter, and an outlet; said inlet and said outlet connecting with said liquid container, said circulation generator forcing said liquid entering said inlet and then passing through said circulation filter for filtering and finally flowing back to said liquid container via said outlet.

3. The laser cutting device for a workpiece having a surface immersed in a liquid as claimed in claim 2, further comprising:
a supplier for supplying a predetermined object mixed with said liquid.

4. The laser cutting device for a workpiece having a surface immersed in a liquid as claimed in claim 1, further comprising:
a plurality of supports disposed between said liquid container and said first surface of said workpiece so as to support said workpiece.

5. The laser cutting device for a workpiece having a surface immersed in a liquid as claimed in claim 4, wherein each support including a sucking portion, an inlet passage, an outlet passage, a driving portion, and a filtering portion, said driving portion being provided to suck said liquid into said inlet passage and makes the sucking portion generating a sucking force on said first surface of said workpiece; said liquid in said inlet passage being guided into said filtering portion and then being expelled via said outlet passage.

6. The laser cutting device for a workpiece having a surface immersed in a liquid as claimed in claim 4, wherein said support comprises a sucking portion, an inlet passage, an outlet passage, a driving portion, and a filtering portion; said driving portion being provided to suck said liquid into said inlet passage and make the sucking portion generating a sucking force on said first surface of said workpiece; said liquid in said inlet passage being guided into said filtering portion and then being expelled via the outlet passage.

7. The laser cutting device for a workpiece having a surface immersed in a liquid as claimed in claim 1, wherein said a surface of the liquid is higher than said second surface so as to form a liquid thin film; said laser generator including a gas-injecting portion for injecting a gas to said second surface of the workpiece so as to form a gas working zone, said gas working zone forcing said liquid thin film out of said gas working zone.
